(19) United States
(12) Patent Application Publication
(10) Pub. No.: US 2007/0012257 A1
(43) Pub. Date: Jan. 18, 2007

(54) Pet cage with supporting structure

(75) Inventors: Burton L. Siegal, Skokie, IL (US); Jason T. Savitt, Wheaton, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: PREVUE PET PRODUCTS, INC.

(21) Appl. No.: 11/478,430

(22) Filed: Jun. 29, 2006

Related U.S. Application Data
(60) Provisional application No. 60/696,053, filed on Jul. 1, 2005.

(51) Int. Cl. A01K 1/01; A01K 31/04

(52) U.S. Cl. 119/479

(57) ABSTRACT

A pet cage with supporting structures includes an upwardly and outwardly extending apron surrounding the base of the cage configured to redirect ejected debris into a waste drawer inside its base, and at least one latch to position and retain a lower portion of the cage with a gap between the cage and the apron so that there is a generally unimpeded path through which the debris may pass. The latch is capable of releasably, self latching on the cage when the cage is lowered thereon. The cage further includes a waste drawer including side and rear walls having upper tapered portions that extend outwardly and flexibly seal against inner walls of the base of the cage to inhibit liquid or solid waste from passing between them and collecting beneath the waste drawer. A multi-leg stand for the base is also included that assembles without fasteners and is engaged, positioned and releasably retained by at least one pair of grippers disposed on the underside of the base. A set of spacers locate, space and engage the underside of one cage base relative to a top of a second cage.

### CROSS-REFERENCE TO RELATED APPLICATIONS

This application claims priority to U.S. Provisional Patent Application Ser. No. 60/696,053 filed Jul. 1, 2005.

### BACKGROUND

1. Field of the Disclosure

The disclosure generally relates to pet container units and, more particularly, relates to bird cages.

2. Brief Description of Related Technology

Seed, excrement, and other debris from bird cages have long been recognized as one of the strongest consumer objections. This is also true for cages for other small pets. Many attempts at protecting floors and carpets have been made in the past and have proven unsatisfactory from an aesthetic, functional and or a cost standpoint. Past efforts have ranged from surrounding the cage with overlapping sheets of newspapers on the floor, to elasticized fabric skirts that surround the cage, to devices that approximate an inverted umbrella.

These past efforts sometimes employ a fabric or other hard to clean surfaces that are as difficult to clean or more so than cleaning the floor they were meant to protect. Some large and expensive cages with metal bases have been made with outward extending metal flanges that are angled upward in an effort to deal with this problem. However, the pet products industry has been unable to accomplish this feature in inexpensive, molded plastic cage bases that are used widely in the mass market for pet cages.

Another previously unsolved problem has been the accumulation of liquids and waste between a debris drawer and the inside of the cage's base. Be they metal, plastic or a combination thereof, there must be clearance between the sides of the drawer and the insides of the base from which the drawer may be pulled for cleaning. This minimum clearance must exceed the sum of the expected manufacturing plus tolerances of the drawer and the negative tolerance of the base. The actual clearance is normally much greater. This is a major problem due to gaps at the sides and to a lesser extent, at the rear of the drawer. Any deviation from a straight and square contact at the rear will add to the existing gap due to the drawer not being fully inserted and maintained in contact at its rear. Only the front end of existing drawers may be free from this problem as its interior surface may be located slightly outside of the front interior surface of the cage's base. Solid waste may accumulate in the vertical gaps between the drawer and the base, but splashed and spilled water and liquid waste can wick beyond the vertical gaps into the broad horizontal gap between the underside of the drawer and the bottom of the base. This liquid can become a breeding media for mold, fungus and bacteria which can be harmful to the pet as well as the pet owners and their families.

Cages, if not resting on a piece of furniture, are commonly supported by either hanging from above or resting upon a supporting stand to elevate the pet closer to eye level. These supporting stands are commonly made so that they may be user assembled to reduce costs but equally important, to reduce shipping and retailing shelf space. Benefits that would greatly add to the commercial success of such a stand include: (1) quick assembly of the stand without the use of tools or fasteners; (2) quick disassembly of the stand for moving; and (3) low-cost but good structural integrity and small carton size. A further merchandising problem related to cage stands is that they have considerable variation in length and width creating a serious disincentive for a retailer to stock them in more than a few sizes, if at all.

There is also a need for a simple, aesthetically acceptable means for pet retailers, breeders and those with large collections of pets to vertically stack cages. Simply resting one cage upon another is not a very acceptable solution as it greatly inhibits both light and air flow into the lower cage. It is not uncommon to see such cage owners using short, square sticks of wood, diagonally positioned near the corners of the cages to create some air space between the layers of cages. While the aesthetic short comings of such a solution are obvious, this attempted solution creates the potential for stressing the pet and spilling water and food into the cage below and onto the floor when the stack of cages is bumped, for example by a passerby causing the cage to slip off one or more of the sticks it is resting upon.

To make a pet cage commercially successful it should have functional and aesthetic appeal coupled with an attractive price relative to the competing products that the consumer is considering. If the concerns of the retailer, such as compact shelf space, ease of assembly and display, and ease of disassembly after purchase, for example, are not addressed, the consumer might not have the opportunity to consider such a pet cage.

In addition, the capability of catching falling and ejected debris and returning it to the waste drawer of a pet cage is a highly desirable marketing feature and one that is instantly recognized by a knowledgeable pet owner. While a small number of large and/or custom made, expensive pet cages with metal bases have been made with upward sloping metal flanges, the makers of low cost, mass market pet cages with plastic molded bases have not been able to create a molded base with a circumscribing apron extending outward and upward to do this. Among the reasons why they were unable to accomplish this are the fact that such an apron with a useful horizontal projection would add a substantial increase to the area of the base as this increase is being added to the perimeter of the original rectangular area. The cost of the added material required is multiplied by the general fact that as the size of a molded plastic part increases, its wall thickness must also be increased.

Regardless of instructions or warning labels, users inevitably will try to pick up the cage by grasping the edges of its protruding aprons. This reason alone would be cause for a material increase in the strength of the perimeter apron. As a result, the walls and bottom of the base must be increased in thickness as well. The potential dramatic material cost increase would further be compounded by the fact that molding cycle time must be increased to accommodate the thicker wall sections. These required cost increases would heavily counteract the desirability of this feature in such an extremely cost sensitive market.

Another obstacle is that the metal cages in this market are almost universally made with hinged side walls so they can fold relatively flat to allow them to be placed in a small carton. The molded bases of these cages typically must function to engage and hold the lower edges of the hinged, vertical walls in a rectangular orientation as the walls rest on the surface of their base. This engagement creates a situation where the bottom horizontal wire of the cage's vertical walls would act as a barrier to the flow of waste and debris from sliding inward toward the waste drawer.

A further problem confronting the makers of low cost pet cages, which is also totally unaddressed by the makers of large, expensive pet cages with metal bases, is the fact that waste and debris, both liquid and solid, sliding into the cage from the outside aprons would have to pass over the required gaps between the inside of their bases and the outside of their waste drawers. Their failure to do so would result in a bothersome cleaning problem and create a breeding location for bacteria and mold. As will be shown, the present disclosure solves all of these problems and makes this feature finally possible in low cost cages with molded plastic bases.

### BRIEF DESCRIPTION OF THE DRAWINGS

FIG. 1 is a front elevation view showing a pet cage resting upon a stand with a second pet cage spaced above it and supported by multiple spacers;

FIG. 2 is a front elevation view of the stand and lower cage of FIG. 1 with a partial section illustrating the engagement of the base of the cage and the stand supporting it as well as the engagement of the cage with its base;

FIG. 3 is an enlarged view of the partial section in FIG. 2;

FIG. 4 is an enlarged view of the engagement of the cage base with the stand shown in FIG. 3;

FIG. 5 is a cross-sectional view taken through line (A-A) of FIG. 2 omitting accessories for clarity;

FIG. 6 is similar to FIG. 5 with a broken section to illustrate a portion of the stand supporting and engaged with the base of the cage;

FIG. 7 is an enlarged portion of the sectional view in FIG. 6 illustrating that portion of the base that is in engagement with a portion of the stand;

FIG. 8 is a top plan view of the stand;

FIG. 9 is an enlarged view taken through line B-B of FIG. 8;

FIG. 10 is an enlarged view of a corner portion of FIG. 5, illustrating two types of engagement between the cage and its base;

FIG. 11 is an enlarged view of a portion of FIG. 10, illustrating a type of engagement that restrains the cage in a horizontal plane relative to the base;

FIG. 12 is an enlarged view of a portion of FIG. 10, illustrating a type of engagement that restrains the cage in both horizontal and vertical planes relative to the base;

FIG. 13 is a side view along line C-C of FIG. 12;

FIG. 14 is an enlarged view of section D-D taken through FIG. 13;

FIG. 15 is a plan view of a waste drawer of the cage;

FIG. 16 is a view of section E-E taken through FIG. 15;

FIG. 17 is a front elevation of FIG. 15;

FIG. 18 is the underside view of FIG. 17;

FIG. 19 is an enlarged view of a portion of the sectional view in FIG. 3;

FIG. 20 is a view of a portion of the waste drawer shown in FIG. 19, prior to being inserted into the cage's base;

FIG. 21 is an enlarged partial portion of FIG. 15;

FIG. 22 is a partial view of section H-H taken through FIG. 2;

FIG. 23 is an enlarged partial view of section M-M taken through FIG. 1 with the waste drawer omitted to better illustrate the engagement of the stacking spacers that connect the two cages;

FIG. 24 is the plan view of a stacking spacer from the perspective of section F-F of FIG. 23;

FIG. 25 is an enlarged view of a portion of section G-G in FIG. 23;

FIG. 26 is a partial elevation view of a first alternative stacking spacer showing a portion of the upper and lower cages with which it is engaged;

FIG. 27 is an enlarged partial view of section H-H in FIG. 26, illustrating an alternative engagement of the stacking spacer with the underside of the upper cage's base;

FIG. 28 is a partial view of section J-J in FIG. 26;

FIG. 29 is the plan view of the first alternative stacking spacer illustrated in FIG. 26;

FIG. 30 is a plan view of a second alternative stacking spacer;

FIG. 31 is a view of section K-K in FIG. 30 with a partial elevation of a cage supporting the second alternative stacking spacer and a partial sectional view of the base of a cage above it illustrating another alternative engagement of the stacking spacer and the base of a cage;

FIG. 32 is a plan view of a third alternative stacking spacer resting upon the top of a lower cage;

FIG. 33 is a view of section L-L in FIG. 32 with a partial sectional elevation of a cage supporting the third alternative stacking spacer and a partial sectional view of the base of a cage above it illustrating another alternative engagement of the stacking spacer and the base of a cage; and

FIG. 34 is a view of the underside of the base of the cage.

### DETAILED DESCRIPTION

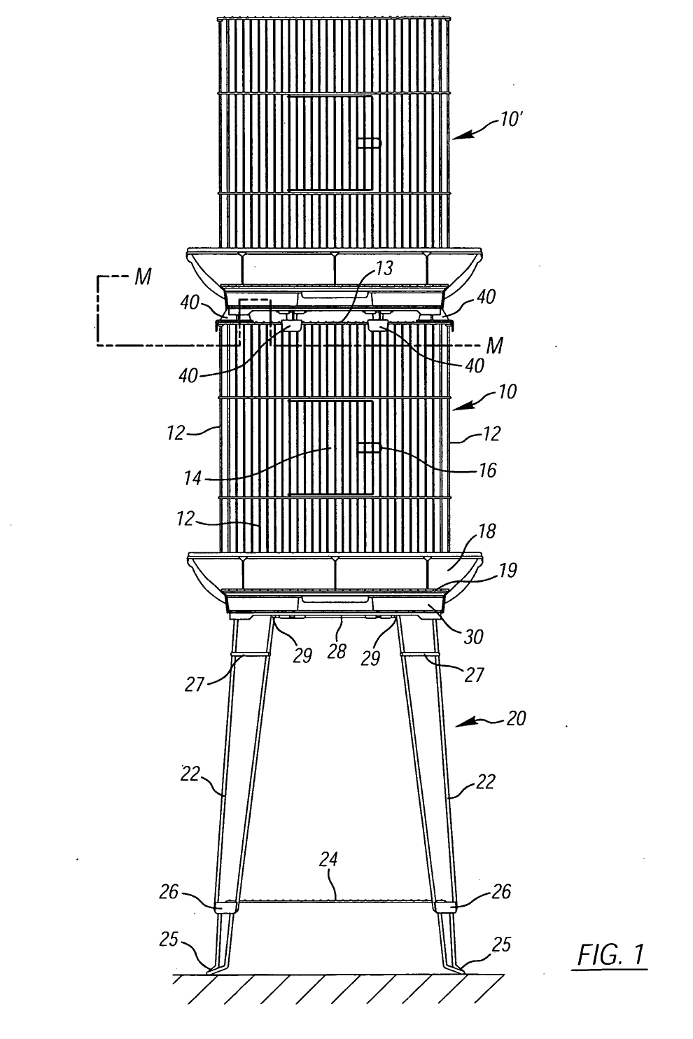

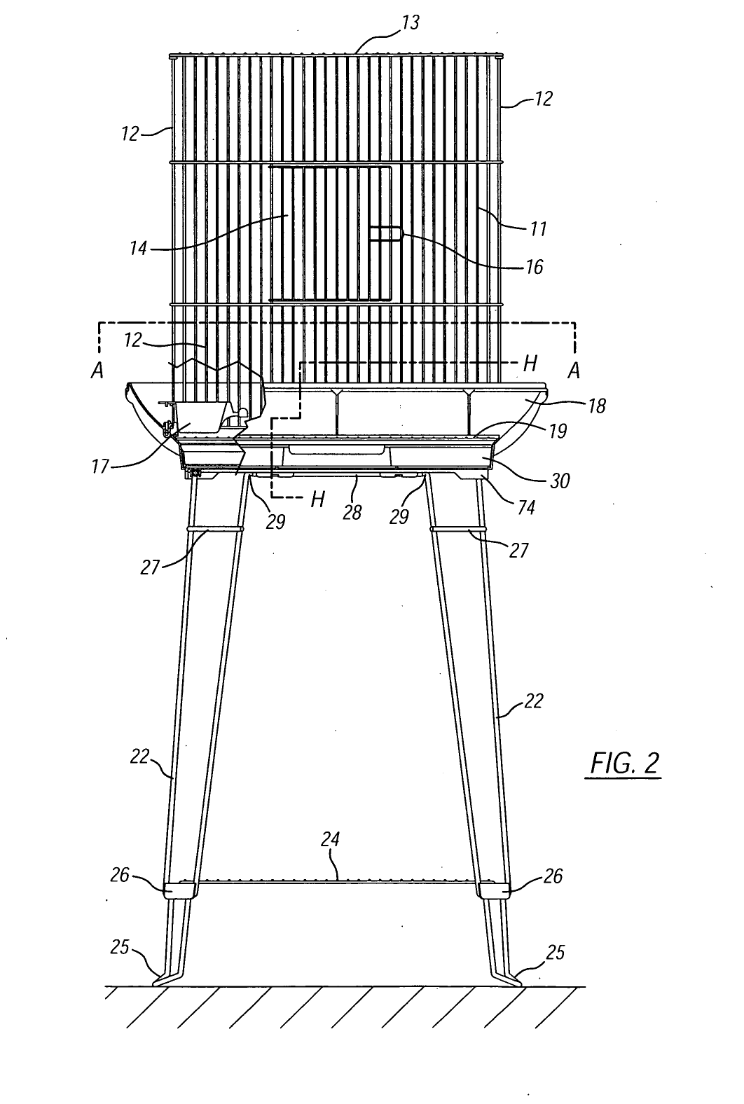

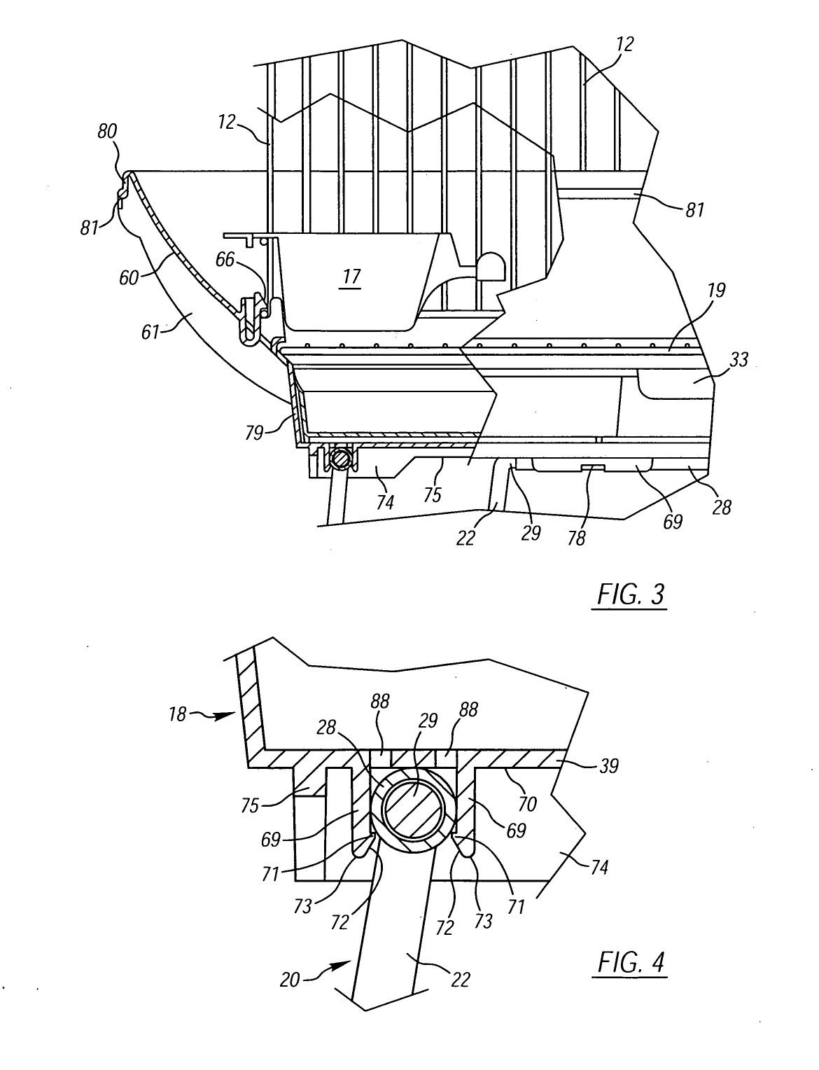

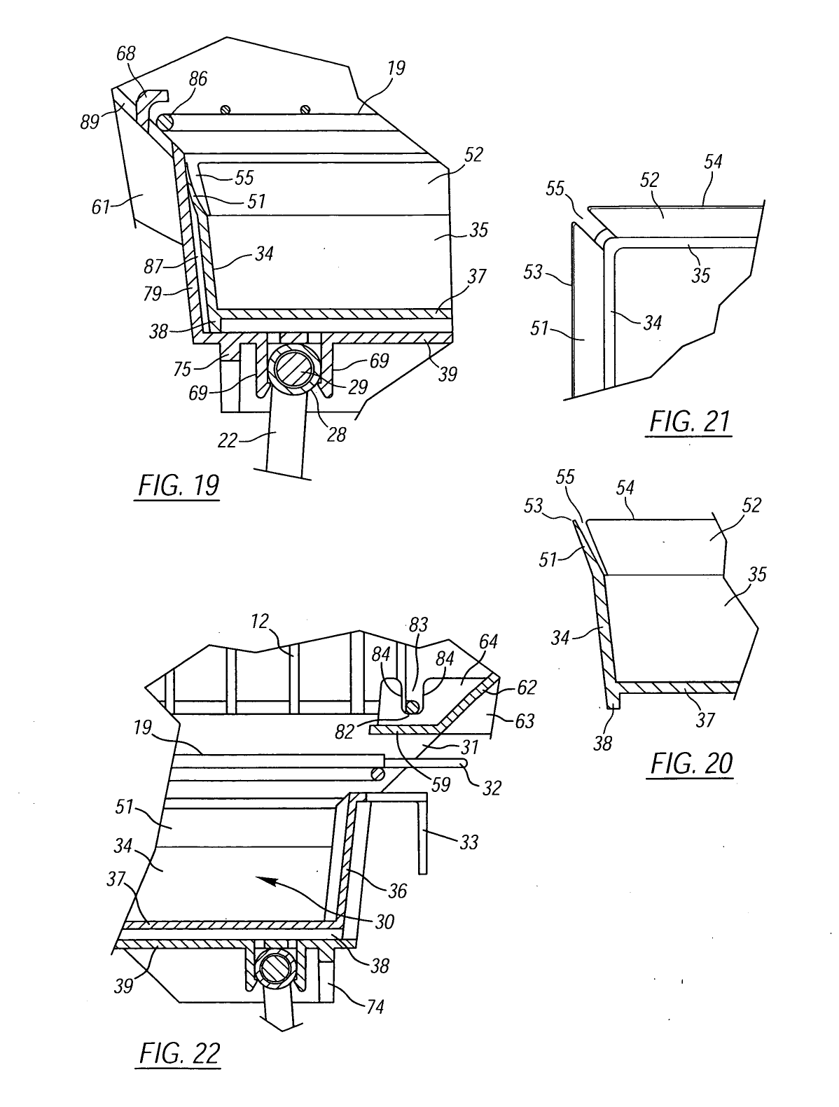

FIG. 1 shows a pet cage 10 having a perimeter wall 12 and a roof 13 resting upon a stand 20 and supporting a second pet cage 10′ by means of multiple stacking spacers 40. FIG. 2 shows only a pet cage 10 resting upon the stand 20; The perimeter wall 12 may include a plurality of vertical walls, which may be constructed of conventional wire mesh having fill wires 11 that are preferably orientated vertically. At least one part of the perimeter wall 12 has a conventional swinging or sliding access door 14 that can be maintained in the closed position by a conventional latch 16 when desired. A top of the pet cage 10 is enclosed by the generally horizontal roof 13 which may also be of conventional wire mesh construction. The vertical walls 12 of the pet cage 10 engage and are latched to a base 18. Within the base 18 is a conventional, wire mesh bottom grill 19 that functions to prevent pets from contacting waste and debris that is collected in a waste drawer 30. As best illustrated in FIG. 19, the grill 19 rests on a pair of surfaces of the base 18 above the waste drawer 30 and is restrained from rising by multiple hooks 68. Other than illustrating a feeding cup 17 in FIGS. 2 and 3, other commonly found components in pet cages have been purposely omitted for clarity. As best illustrated in FIG. 22, the bottom grill 19 and the waste drawer 30 slide into the base 18 through a front wall having an opening 31. The bottom grill 19 and the waste drawer 30 may have integral pull handles 32 and 33, respectively.

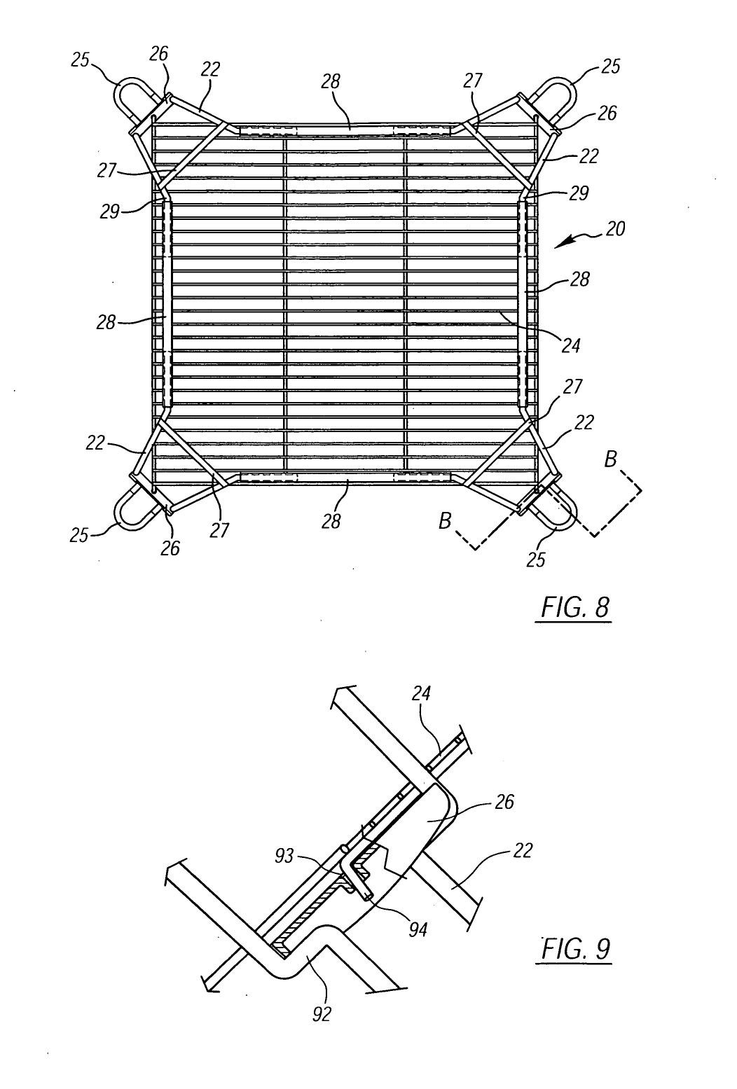

Referring now to FIGS. 1 and 2, the stand 20 may include substantially similar multiple legs 22, a horizontal member 24 that engages and stabilizes the legs 22 near their lower extremity, and a clip 26 that is attached to each of the legs 22 and engages the horizontal member 24. As better shown in FIGS. 3 and 4, a tubular sleeve 28 may interconnect horizontally projecting upper ends 29 of adjacent legs 22. The horizontal member 24 and the clip 26 are best illustrated in FIGS. 8 and 9. Spaced below the upper ends 29 may be a cross tie 27 that stiffens and stabilizes the upper ends 29 of the legs 22. Lower ends of the legs 22 may terminate in a bent foot 25 that rests upon the floor.

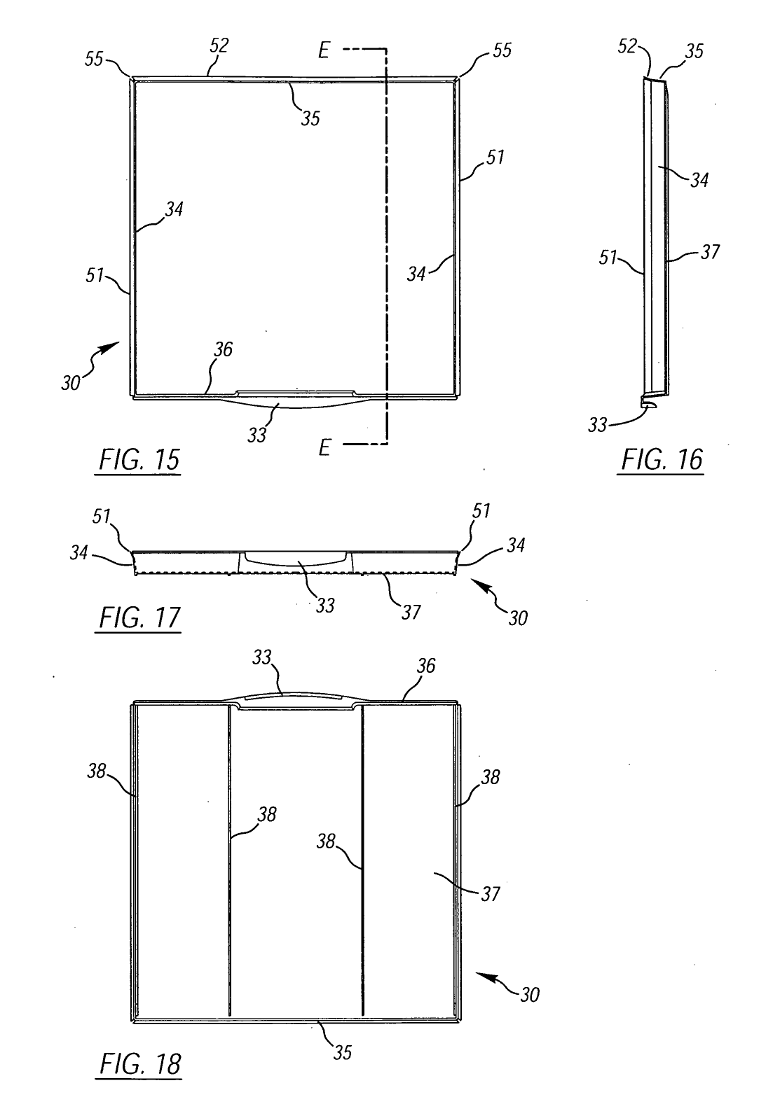

The waste drawer 30, which is best illustrated in FIGS. 15 through 22, includes an upstanding wall that may advantageously comprise side walls 34 and a rear wall 35. A front wall 36 includes the pull handle 33. An underside of the drawer 37 may include multiple rub ribs 38 that support the waste drawer 30 and which may slide upon and ultimately rest upon a bottom 39 of the base 18, as seen in FIG. 19. The upper portions 51 and 52 of the side walls 34 and rear wall 35 respectively, as seen in FIGS. 16, 17 and 19, taper to a thin edge 53 and 54 respectively, which are angled further from the vertical than are the walls 34 and 35. These upper portions 51 and 52 are separated by a notch 55 that extends downwardly from a top of the upper portions 51 and 52 to their beginning at the upper ends of walls 34 and 35, respectively.

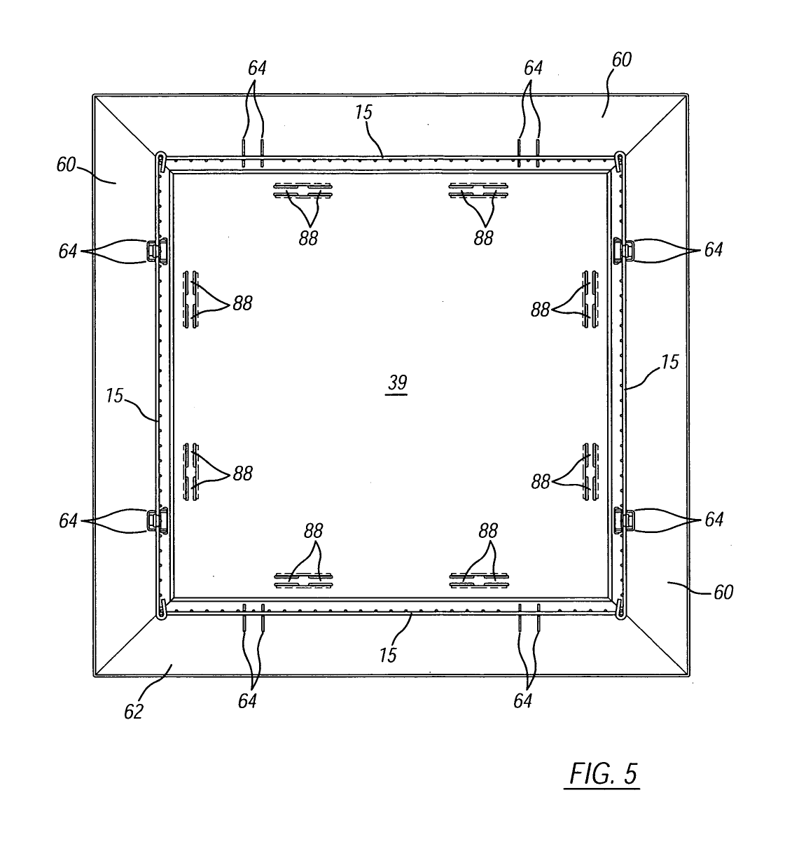

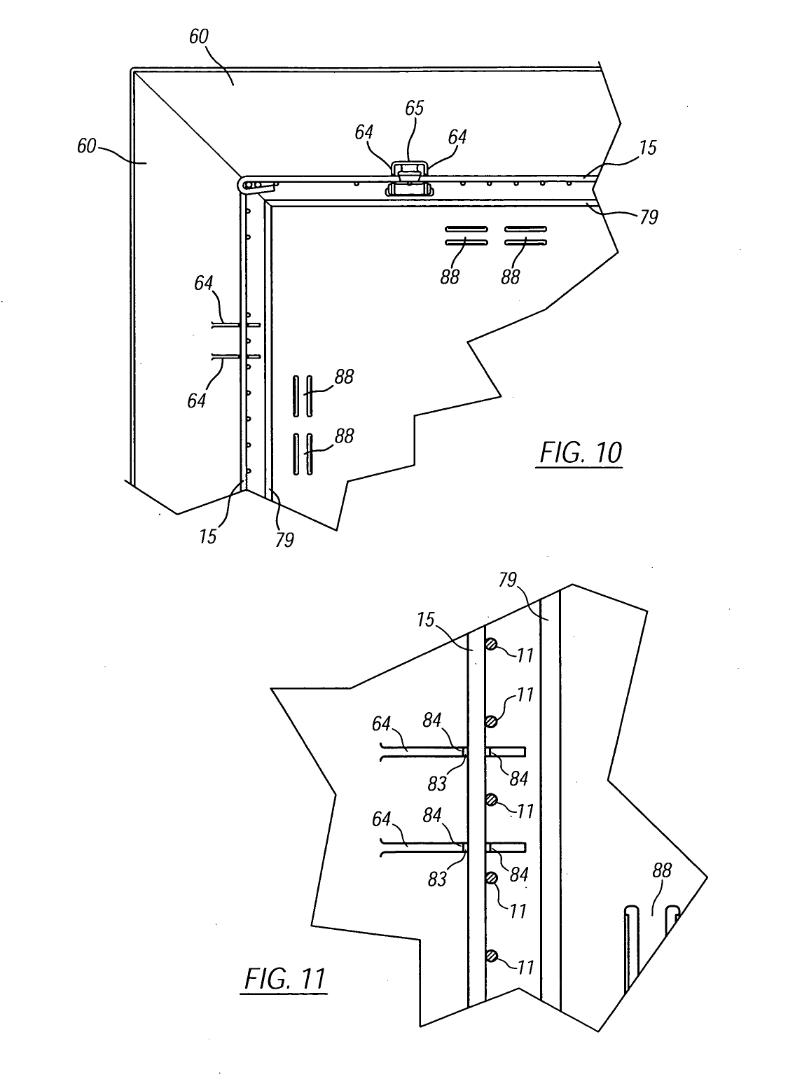

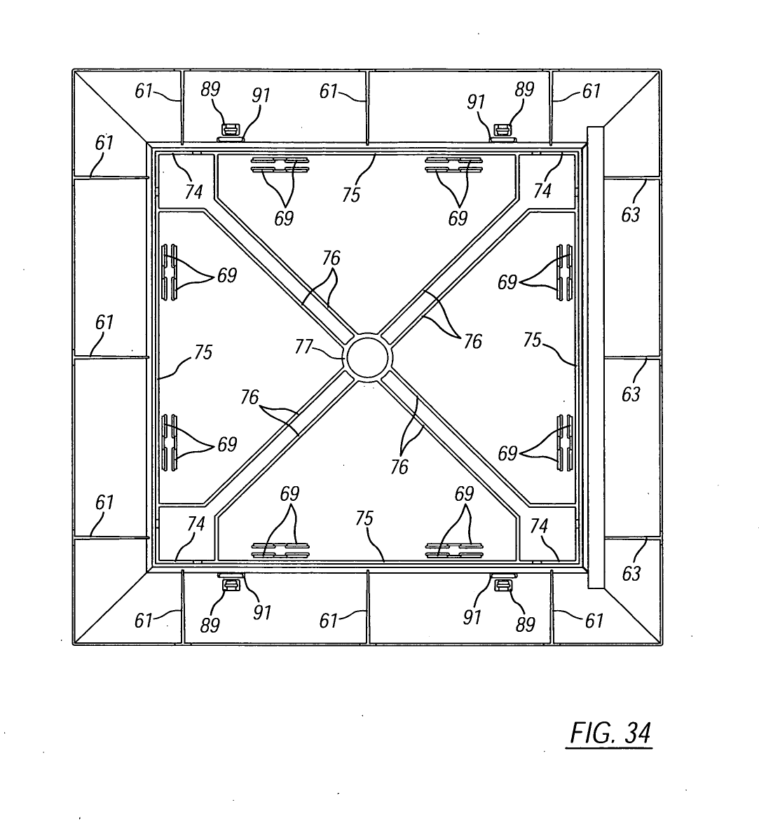

As illustrated in FIG. 5, the base 18 preferably has integral, outwardly and upwardly extending side, rear and front aprons 60, 62. The side and/or rear aprons 60 are preferably substantially similar. The front apron 62 terminates at the upper extent of the opening 31 (FIG. 22). The side or rear aprons 60 and the front apron 62 may be stiffened and supported by multiple gussets 61 and 63 respectively (FIG. 34). As best illustrated in FIG. 22, bottoms of the multiple front gussets 63 do not extend below the upper extent of the opening 31. This upper extent of the opening 31 is defined by a generally horizontal flange 59 that extends inwardly from the front apron 62 to generally overlap the front wall 36 of the waste drawer 30. Referring to FIGS. 5 and 10 through 14, extending upwardly from the side or rear aprons 60 and the front apron 62, are multiple positioning and support ribs 64. Centered between pairs of the positioning and support ribs 64 and, preferably in two places on each of the side aprons 60, is a cage latch 66 (FIG. 14). At those locations, the pairs of the positioning and support ribs 64 are connected by a web 65 spaced from and located outside of the cage latch 66 (FIGS. 10 and 14). As best shown in FIG. 14, a laterally extended hook 68 rises above a surface of the side aprons 60. This structure may be duplicated on each side apron 60 where each cage latch 66 is located.

As best illustrated in FIG. 4, descending from the lower surface 70 of the bottom 39 of the base 18 are multiple pairs of gripping fingers 69 which may include facing hooks 71 and guiding tapers 72 that end at a narrow tip 73. Aperture pairs 88 may be located wherever pairs of gripping fingers 69 are located. As illustrated in FIG. 5, the pairs of gripping fingers 69 which are generally hidden in this view, may be located where ever the aperture pairs 88 are shown and may be positioned an equal distance from corners of the base 18. The base 18 may also include short legs 74 disposed in the corners of the base 18 connected by a much shorter perimeter rib 75. As best illustrated in FIG. 34, on a lower surface 70 of the bottom 39 are multiple feed runners 76 with a generally radial orientation, which blend into the perimeter ribs 75 and originate from a centrally located distribution ring 77. To avoid confusion and to better illustrate the other features and functions of the base 18, the multiple feed runners 76 and the distribution ring 77 are not shown in the other figures in which they might appear.

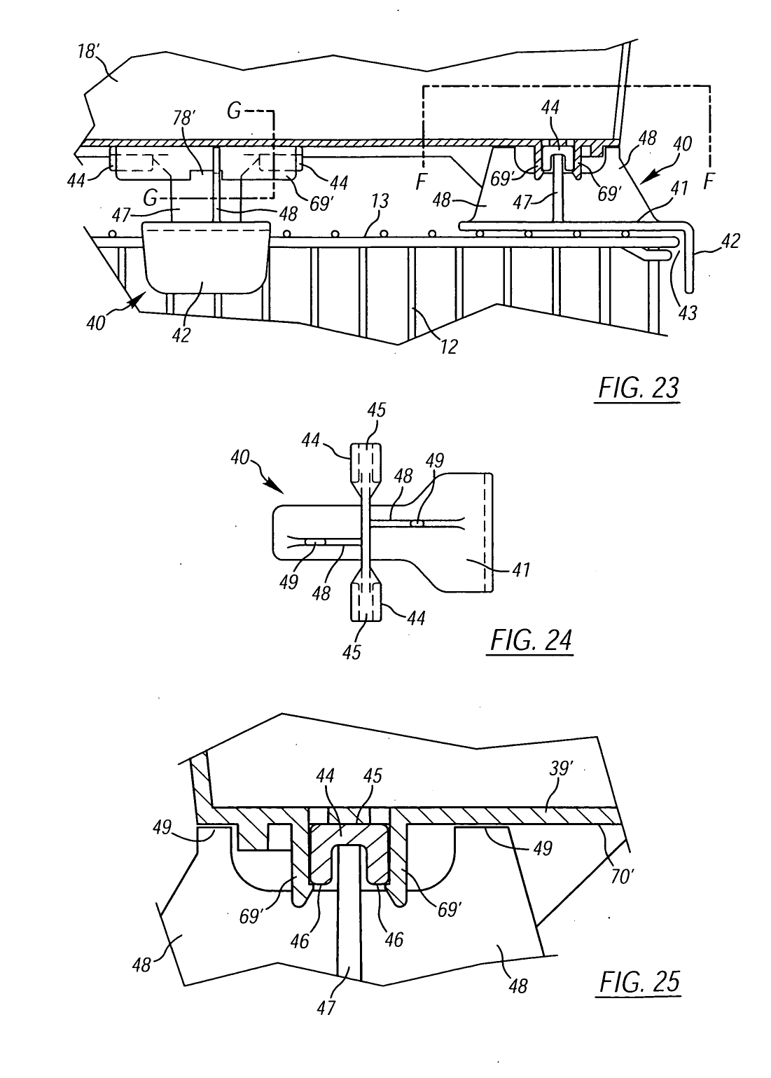

The preferred embodiment of the stacking spacer 40 is best illustrated in FIGS. 23, 24 and 25. The stacking spacer 40 has a main member 41 that when in use, rests upon the roof 13 of the cage 10. The stacking spacer 40 may also include a downwardly extending flange 42 that preferably is positioned with a small clearance 43 to a perimeter of the roof 13 and the vertical walls 12 of the cage 10. At a top of the stacking spacer 40 is one or more cross-members 44 having an upper surface 45 that is generally flat to better support an underside 70′ of a bottom 39′ of the second cage 10′. The lower extremities 46 of the cross-members 44 are shaped to engage with and be removably retained by gripping fingers 69′ of the second cage 10′. The cross-members 44 are supported by a vertical web 47 which rises from the main member 41. The vertical web 47 may be braced by one or more gussets 48 having an upper flat surface 49 that may have enough clearance from the underside 70′ of the bottom 39′ of the second cage 10′ to insure that the gripping fingers 69′ fully engage the lower extremities 46 of the cross-members 44. The gripping fingers 69′ have a notch 78′ that is engaged by the gussets 48 to limit the axial motion of the stacking spacer 40 relative to the gripping fingers 69′ of the bottom 39′ of the second cage 10′. Other means of restricting the axial movement of the stacking spacer 40 relative to the gripping fingers 69′ are contemplated herein.

In this preferred embodiment, the lower extremities 46 of the cross-members 44 are first engaged into the gripping fingers 69′ of the bottom 39′ of the second cage 10′. By virtue of the close proximity of the flat surface 49 to the underside 70′ of the bottom 39′ of the second cage 10′, the stacking spacers 40 cannot rotate and their downwardly extending flanges 42 are maintained in a vertical position with the clearance 43 generally maintained as the second cage 10′ and its attached stacking spacers 40 are lowered on to a pet cage 10 to be supported by and spaced above it. The engagement of the gripping fingers 69′ with the cross-members 44 may be sufficient to prevent rotation of the stacking spacers 40 without the additional stability provided by the close proximity of the flat surface 49 to the underside 70′ of the bottom 39′ of the second cage 10′. It was included in the preferred embodiment because of the additional support and stress distribution the flat surface 49 may provide.

The spacing provided by the stacking spacers 40 is important for ventilation and lighting of the cage below. The firm, three dimensional engagement to the second cage 10′ and close fitting overlap of the supporting cage 10 provided by the stacking spacers 40 insures that the second cage 10′ is extremely unlikely to be dislodged. In the preferred embodiment, the stacking spacers 40 may be made of a clear material to avoid impeding light to, or view of the pet in the lower cage 10. The stacking spacer 40 provides a pet cage improvement, important to those users who have many cages such as breeders and pet stores. It is fully anticipated that alternative or equivalent configurations of the stacking spacers 40 may be used, some of which will later be described.

A further feature of the disclosure is to avoid the unattractive flat surface flanges of existing art. Flat plastic surfaces exaggerate plastic molding flaws and are not as strong or attractive as curved surfaces. As illustrated in FIG. 3, the side or rear aprons 60 and the front apron 62 (not shown), are curved upwardly for a functional reason as well as for cosmetic and strength purposes. For example, debris falling and striking the aprons 60 and 62 further away from the vertical walls 12 have a longer distance to be bounced, slid or otherwise propelled to the waste drawer 30 that will ultimately receive it. With an upward curve to the surfaces of the aprons 60 and 62, the horizontal vector of the rebound force on the debris increases as an impact point gets further from the vertical walls 12 of the cage 10. To maximize the effectiveness of this feature, the feeding cups 17 should be located as low as is practical in the vertical walls 12 of pet cage 10.

With the cage 10 constructed as disclosed herein, it is possible to avoid increasing the wall thickness of the molded base, and actually allows the wall thickness to be decreased from what was customarily used in molded bases of similar overall size. Using a square base with an overall length of 22 inches as an example, the cage 10 may have a typical wall thickness of only 0.080″ using high impact polystyrene resin. Prior art cages would customarily have a wall thickness of between 0.125 to 0.140″. Referring to FIG. 34, the molding resin may be injected in the center of the distribution ring 77 which is of a substantially larger cross section than the basic wall thickness. The feed runners 76 which also have a larger cross section, radiate from the distribution ring 77 to encourage the flow of resin toward the perimeter ribs 75. From there the flow is upward into the side or rear walls 79 of the base 18, as better shown in FIG. 3. The flow continues through the side and rear aprons 60 and the side or rear gussets 61 that stiffen and support them. The side and rear aprons 60 and the front apron 62 terminate in a stiffening flange 80 which along with the side and rear gussets 61 and the front gussets 63, may contribute rigidity to the thin walls to permit confident lifting of the entire cage 10. The walls of the side and rear aprons 60, the front apron 62 and the stiffening flanges 80 may be so thin that the stiffening flanges 80 terminate in a bulb 81 to give the consumer an impression that the walls are much thicker than they really are and to prevent the walls of stiffing flange 80 from cutting into the consumers' fingers when lifting the cage 10. The feed runners 76 are oriented towards the corners of the base 18 to promote a lateral flow of resin in the side or rear walls 79 and the side and rear aprons 60. Referring to FIG. 22, on the front of the base 18, there is the opening 31 to receive the waste drawer 30 and the bottom grill 19. The flow of the resin to the front apron 62, the front gussets 63 and the flange 59 may be accomplished by lateral flow from the corners.

These improvements may dramatically reduce the cost increase which would have been expected from the large area increase required for the circumscribing, debris catching aprons and may improve its function enough to become commercially feasible to incorporate this feature in low cost, mass market pet cages with molded plastic bases. While the preferred embodiment described herein is one in which the side or rear aprons 60 and the front apron 62 are molded integral with the base 18, it is anticipated that these aprons may be made as separate parts that can either hook into or be fastened to the balance of the base 18 and each other. The choice between the options is principally a trade off between the cost and complexity savings of the former against the expected smaller carton size of the latter.

As illustrated in FIG. 5 and in more detail in FIGS. 10 through 14, the cage 10 eliminates the bottom wire 15 of the vertical walls 12 of the cage 10 from acting as a barrier to the flow of waste and debris sliding off the aprons 60 and 62. The bottom wire 15 is supported at a spaced interval above the surface of the aprons 60 and 62 by resting upon the bottom 82 of a vertical notch 83. The positioning and support ribs 64 are located at least once, but preferably twice on each of the aprons 60 and 62. The support ribs 64 may be individual, but preferably are in close coupled pairs as illustrated. The walls 84 of notch 83 are spaced apart a distance greater than the width of the bottom wire 15 so as to easily accept it and restrict its movement in the horizontal plane. The positioning and support ribs 64 are positioned in the horizontal plane to be located approximately midway between the vertical fill wires 11 of the vertical walls 12 of the pet cage 10 so that even with the expected tolerance in the placement of the fill wires 11 there will be no interference between them and the positioning and support ribs 64. Alternatively, if the fill wires 11 were horizontal, this positioning requirement would not be necessary. Thus, the positioning and support ribs 64 may support and position the bottom wire 15 of vertical walls 12 above the surface of the aprons 60 and 62 so that debris may slide under the bottom wire 15 and into the waste drawer 30. Additionally, the positioning and support ribs 64 may position the vertical walls 12 in a horizontal plane relative to the base 18 to keep the hinged vertical walls 12 in their rectangular orientation. This positioning function would be required even if the positioning and support ribs 64 were cooperating with the vertical walls of a welded, rigid cage.

Working in conjunction with the positioning and support ribs 64, as illustrated in FIG. 13, may be the cantilevered, cage latch 66 which will deflect outwardly by the bottom wire 15 upon the vertical walls 12 being pushed down into the positioning and support ribs 64. The cage latch 66 may spring back so that the tapered barb 67 will be above the bottom wire 15 thus locking the vertical walls 12 to the base 18. The taper on the tapered barb 67 causes the cage latch 66 to be deflected outwardly by the downward motion of the bottom wire 15. In the preferred embodiment, the cage latch 66 may be positioned between a pair of the positioning and support ribs 64 and at lease one, preferably two, would be used on each of two opposed aprons 60 and 62. The cage latch 66 may be employed on all the aprons 60 and 62, but this may make unlatching the vertical walls 12, much more and needlessly tedious. The tapered barb 67 is potentially a fragile part which might be easily damaged by the consumer assembling the cage. Accordingly, means to protect the tapered barb 67 are contemplated herein.

To keep the deflection of the tapered barb 67 within its elastic limit, a web 65 may be placed outside of the tapered barb 67. The web 65 may be spaced from the tapered barb 67 a sufficient distance to permit it to deflect far enough to clear the bottom wire 15, but not so far as to exceed the elastic limit of its cantilevered support. The web 65 also gives added lateral strength to the pair of positioning and support ribs 64 it spans. To prevent the possibility of the bottom wire 15 descending outside or behind the tapered barb 67 such as, for example, by inadvertently pushing it inward and over stressing or breaking it, tops 85 of the positioning and support ribs 64 are connected by the web 65 and are elevated slightly above the tapered barb 67. The descent of the bottom wire 15 outside of the tapered barb 67 would be halted by the top 85 of the positioning and support ribs 64 above the top of the tapered barb 67. Should the consumer lower the vertical walls 12 so far from the correct position that the bottom wire 15 descends outside of the web 65, no damage is likely to result since the inward thrust would be resisted by the relatively strong structure of the web 65, as it may be reinforced by the pair of the positioning and support ribs 64 it spans. The webs 65 are preferably short in length as they constitute the only impediment to the free flow of debris down from the aprons 60 and 62.

The tapered barb 67 of cage latch 66 may be located inside of the bottom wire 15 of the vertical walls 12 as an alternative to the preferred embodiment illustrated. As best seen in FIG. 14, the preferred embodiment has the advantage of allowing release of the cage latch 66 by the simple act of pressing a finger tip into the gap between its narrow tip 84 and the vertical walls 12 to deflect the tapered barb 67 outwardly which may allow a slight lift of the vertical wall 12 above its latched location. The cage 10 may be released from its base 18, one side at a time, wherein the cage latches 66 are disposed on only two opposing sides.

As illustrated in FIGS. 13 and 14, positioned on each of the side aprons 60 may be two laterally extending hooks 68 which may serve to retain and guide edges 86 of the bottom grill 19 when it is slid in or out of the base 18 through its opening 31. The underside of the edges 86 of the bottom grill 19 rest upon a surface of the side aprons 60 adjacent to side walls 79 of the base 18. Other than being on the side aprons 60, and being positioned to keep the bottom grill 19 from tipping downwardly when being withdrawn, the front to rear location of the laterally extended hooks 68 is arbitrary. In the preferred embodiment, the hooks 68 are positioned beneath pairs of positioning and support ribs 64. The bottom grill 19 is withdrawn from the base 18 using the pull handle 32 (FIG. 22). Beneath the bottom grill 19 and resting upon the bottom 39 of the base 18 is the waste drawer 30, as is illustrated in FIGS. 19 through 22. When the drawer 30 is inserted into the opening 31, the upward excursion of the rear wall 35 of the waste drawer 30 is limited by the underside of the bottom grill 19. There are multiple rub ribs 38 on the underside of the drawer bottom 37 that slide on the bottom 39 of the base 18 (FIG. 18). The side walls 34 and the rear wall 35 of the waste drawer 30 are generally parallel to and spaced inward for working clearance 87 from the side or rear walls 79 of the base 18, as best illustrated in FIG. 19. As molded, the waste drawer's 30 upper portions 51 of the side walls 34 and the upper portion 52 of the rear wall 35 project outward a greater distance than the clearance 87. This is best illustrated by contrasting FIG. 20. with FIG. 19. The upper portions 51 and 52, taper to very thin edges 53 and 54 respectively. When inserted into the base 18, these upper portions 51 and 52 are forced to flex and conform to the surface of the side or rear walls 79 of the base 18, as illustrated in FIG. 19. The geometry of the flexure is limited to being below the elastic limit of the plastic selected for use on the waste drawer 30. The side upper portion 51 and the rear upper portion 52 of the walls of the waste drawer 30 causes a squeegee blade-like action that seals the working clearance 87 between the waste drawer 30 and the side or rear walls 79 of the base 18. Liquid and solid waste or debris are extremely unlikely to fall between the walls as they cascade down into the waste drawer 30.

Referring to FIG. 22, the horizontal flange 59 that extends from the bottom of the front apron 62 and defines the upper extent of the opening 31 through which the bottom grill 19 and the waste drawer 30 enter, serves as a conduit for debris sliding off the front apron 62. Since the horizontal flange 59 overhangs the front wall 36 of the waste drawer 30, the debris from the front apron 62 falls inside the waste drawer 30. The flexure of the rear upper portion 52 is created by pushing the waste drawer 30 fully into the base 18. If there is a relatively low coefficient of friction between the rub strips 38 and the bottom 39 of the base 18, one may expect the waste drawer to be urged forward by the flexural force of the deflected rear upper portion 52 and thus breaking the seal that was created by its full insertion. However, the partial ejection of the waste drawer 30 is resisted by a frictional grip of the two side upper portions 51 on the side walls 79 of the base 18. This may be in addition or as an alternative to the friction grip due to the weight of the waste drawer 30 resting upon the bottom 39 of the base 18. If the coefficient of friction between the two plastic surfaces of the waste drawer 30 and the base 18 was 0.5μ, for example, the side wall grip alone may be enough to resist a springing back force from the rear of the waste drawer 30 equal to the weight of the waste drawer 30. In the event the coefficient was much lower, the waste drawer 30 may move slightly until the force generated by the flexure of the rear upper portion 52 was reduced to the point where it could no longer overcome the frictional resistance opposing it. Even in such case, the rear upper portion 52 may still be partially flexed against the rear wall 79, thereby maintaining a seal against it. As best shown in FIG. 21, the side and rear upper portions 51 and 52 are separated by a notch 55 at the rear corners of the waste drawer 30. The width of the notch 55 may be great enough to allow the side or rear upper portions 51 and 52 respectively, to be deflected upward and inward without touching, as a result of their contact with the with the side or rear walls 79 of the base 18. Any excess width may create a gap through which debris might find its way between the base 18 and the waste drawer 30.

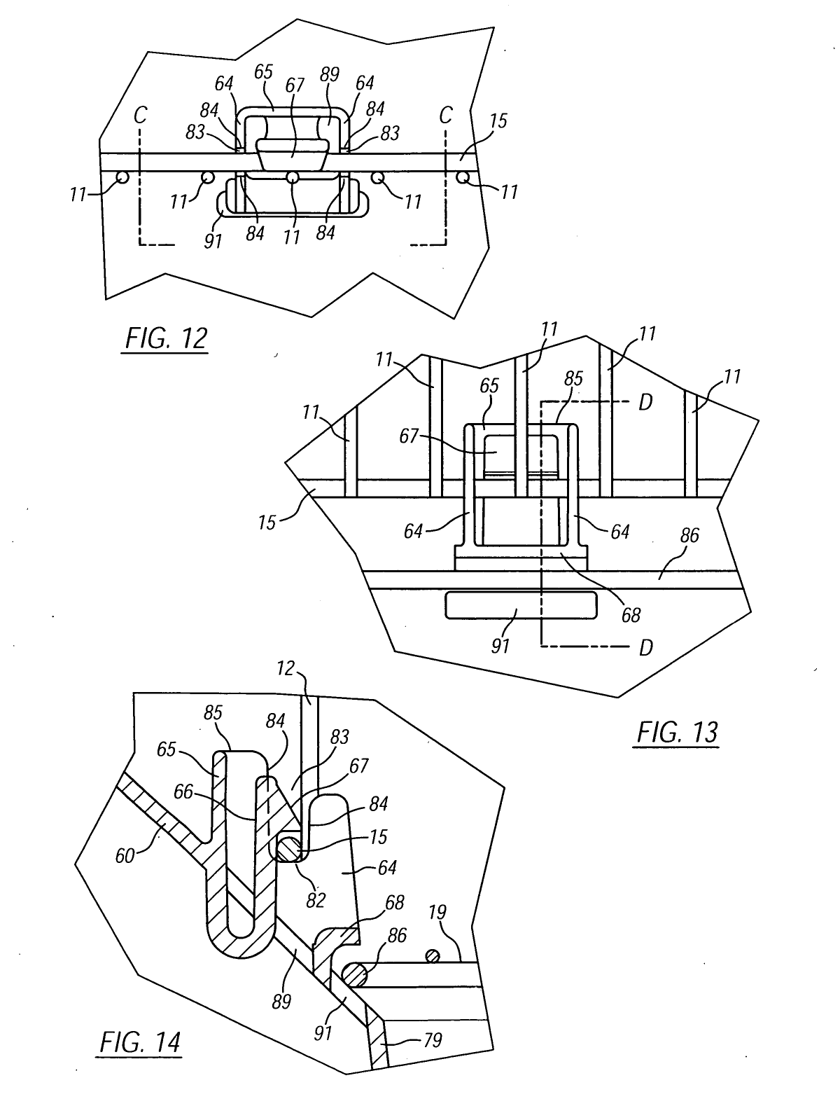

The injection mold that can manufacture the base 18 may be made and operated less expensively as a result of the seal between the walls of the base 18 and the waste drawer 30. For example, spilled water and possibly other liquid waste will no longer have the opportunity to collect on the bottom 39 of the base 18. In addition, this eliminates the worry of liquid leaking through holes in the bottom 39 of the base 18 and onto the floor or carpet. Accordingly, the injection mold from which the base 18 may be manufactured, may be made without the use of expensive and maintenance requiring moving elements that would normally be required to create the undercuts of the facing hooks 71 of the gripping fingers 69. As best illustrated in FIG. 4, pairs of apertures 88 can be made in the bottom 39 of the base 18 which allow the undercuts of the facing hooks 71 to be created by stationary steel that is an integral part of the upper half of the mold. Similarly, referring back to FIGS. 12 and 14, the “U” shaped barrier, created by positioning and support ribs 64 and the web 65, prevent debris from falling through aperture 89 and slot 91 in the side aprons 60. Aperture 89 and slot 91 create the undercuts required for the tapered barb 67 and the laterally extending hook 68 respectively without having to increase the cost of the mold or the maintenance on it caused by moving parts.

The gripping fingers 69, as illustrated in FIG. 4, project a lesser distance than the short legs 74. Therefore, the base 18 of the pet cage 10 gives the user the option of resting it upon either the floor or a table or it can snap onto the stand 20. FIGS. 1 and 2 illustrate the pet cage 10 engaged with and supported by the stand 20. In the preferred embodiment, the four legs 22 are illustrated in a rectangular pattern. However, the stand 20 may include more or fewer legs 22. For example, other stands may have three legs 22 supporting a triangular or circular base 18. As further illustrated in FIGS. 7, 8 and 9, the legs 22 terminate in a pair of horizontal upper ends 29 that are orientated 90 degrees from each other in the case of a four legged stand 20, or 60 degrees, for example, if only three legs 22 were used. As best shown in FIG. 9, near the foot 25 of the multiple legs 22, but preferably high enough to clear the head of a vacuum cleaner, is an offset kink 92 in each half of the multiple legs 22. Resting upon these offset kinks 92 is a clip 26 which has a hole 93 through which a projecting wire 94 from a corner of a horizontal member 24 descends. The clip 26 is gripped by the leg 22 by virtue of being wedged between its halves. An alternative to the clip 26 would be a bracket with a hole or a wire with a central loop that could be welded to the leg 22. The horizontal member 24 may stabilize the ends of the legs 22 and give rigidity to the stand 20. It may also function as a shelf for pet related supplies.

Referring to FIGS. 7 and 8, the upper ends 29 may be connected to adjacent legs 22 by tubular sleeves 28. The lengths of the tubular sleeves 28 may be equal to or slightly less than the distance between the two adjacent legs 22 at a point where they make the transition to horizontal at their upper ends 29. The use of the tubular sleeves 28 in combination with the legs 22 allows for multiple lengths and widths of the stand 20. The legs 22 are preferably the same for all size stands. In a preferred embodiment, the legs 22 are tightly nested for shipping, storage and packaging purposes. The changes in length and or width of pet cages may be accommodated, for example, by an extra supply of tubular sleeves 28 in various lengths. The cost and storage needs for such sleeves 28 is minimal. The horizontal member 24, being a thin, low cost part to fabricate and store in inventory would be the only size specific part that may need to be inventoried. Thus, a distributor or retailer could afford to inventory a wide range of stands 20 that would require very little shelf space or investment to do so. In an alternative embodiment, the gripping fingers 69 could be configured to directly grip the upper ends 29 of the legs 22 rather than the tubular sleeves 28. However, as will be shown, the tubular sleeves 28 may contribute considerable strength and convenience to the stand 20.

As best illustrated in FIG. 4, the lower surface 70 of the bottom 39 of the base 18 of pet cage 10 rests on the tubular sleeve 28 that spans and connects the upper ends 29 of the legs 22 of the stand 20. The tubular sleeves 28 are kept in contact with the base 18 by the facing hooks 71 of gripping fingers 69 that descend from the base 18. Ideally, the stand 20 is first assembled as illustrated in. FIG. 8 prior to being attached to the pet cage 10. Without the tubular sleeves 28, the upper ends 29 of the legs 22 would be free to wander laterally and would require one person to hold one leg 22 while another person attempted to engage the upper ends 29 of that one leg 22 with the corresponding two pairs of gripping fingers 69 (FIG. 4) that descend from the base 18. This would be repeated for each additional leg. While the guiding tapers 72 of the gripping fingers 69, as illustrated in FIG. 4, would help somewhat, this would be an awkward assembly. In the preferred embodiment, the tubular sleeves 28 allow one person to easily assemble the stand 20 without the need for any tools. Since all the upper ends 29 are being held in an accurate position relative to each other, the cage 10 may be lowered onto an assembled stand 20 with only a slight downward press to releasably snap the cage 10 in place. Only a slight lateral shift may be needed to engage the guiding tapers 72 of the gripping fingers 69 onto all the tubular sleeves 28. The maximum deflection of the gripping fingers 69 is restricted to under the elastic limit of the plastic resin being used.

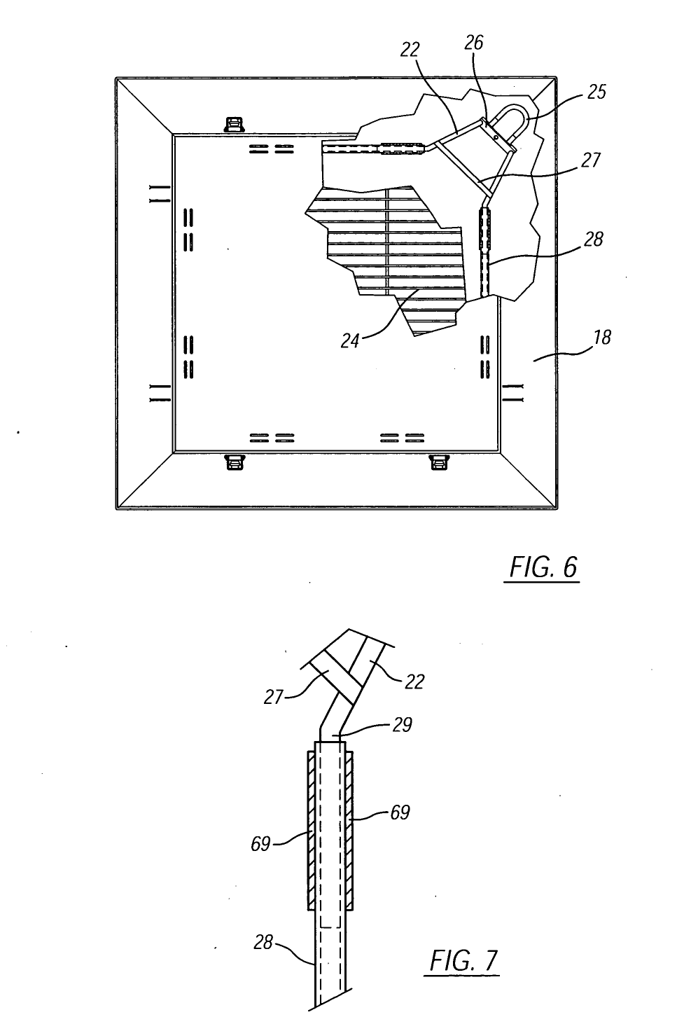

The weight of the cage 10 may be transferred to the stand 20 primarily through the portions of the bottom 39 of the base 18 in the areas immediately above the upper ends 29 of the legs 22 of the stand 20. However, as is best shown in FIG. 4 and FIG. 6, these areas may be weakened by the aperture pairs 88 that make possible the molding of the facing hooks 71 without the need for moving parts in the mold for the base 18. Since the contact between the lower surface 70 of the bottom 39 of the base 18 and the tubular sleeve 28 extend for the entire length of the tubular sleeve 28, any localized deflection in the area of the gripping fingers 69 may result in the load being distributed along the entire length of the tubular sleeves 28.

It is also contemplated that square wire may be used in place of the preferred round wire for the legs 22 and square tubing for the preferred round tubular sleeves 28. Round wire and tubing is preferable because of lower cost and, more importantly, because it allows easier engagement and much easier disengagement with the gripping fingers 69. The square tubing may offer limited resistance to rotating within the grasp of the gripping fingers 69. For example, this would be the case when the legs 22 of the stand 20 encounter an obstruction while the pet cage 10 and the stand 20 are being dragged across a floor. To better visualize this, refer to FIGS. 2 and 3. In such an instance, the leg 22 would tend to fulcrum about a point near where the horizontal member 24 is located. Depending upon the direction the leg 22 is moving when it struck the obstruction, there may be a tendency for one upper end 29 of the leg 22 to rotate within the grasp of the gripping fingers 69 and the other upper end 29 of the leg 22 wanting to rotate upwardly into the bottom 39 of the base 18 or downward breaking the grip of the facing hooks 71 of the gripping fingers 69. The tubular sleeve 28 that encompasses the upper end 29 which is subjected to this rotational force, also encompasses the upper end 29 of an adjacent leg 22. Because of this, the tubular sleeve 28 may act as a strong lever arm which may be sufficient to resist the force of this tendency.

In the preferred embodiment, the legs 22 may be used with the upper ends 29 and the mating gripping fingers 69 angularly displaced from each other. This allows the use of light engagement forces between them while providing a strong, positive location in both lateral and horizontal directions and the downwardly direction between the stand 20 and the pet cage 10. The total sum of the grip in the upwardly direction need only be enough to exceed the weight of the stand 20 and any supplies that might be resting on the horizontal member 24. This will allow the user to carry both the cage 10 and the stand 20 by gripping and lifting the cage 10. While one upper end 29 and its encompassing sleeve 28 are free to slide axially within the grasp of their mating gripping fingers 69, the other upper end 29 and its encompassing sleeve 28 are engaged with their mating gripping fingers 69, which in the case of a four leg stand 20, is at an angle of 90 degrees to the former upper end 29. This configuration prevents axial motion of either upper end 29 of leg 22. In order to eliminate almost any lateral deflection of these upper ends 29 of legs 22 and to help maintain them in an accurate position for easy mating with the base 18, spaced below the upper end 29 may be the cross tie 27 that stiffens and stabilizes the upper ends 29 of the leg 22. Alternatively, a single bent wire serving as both upper ends 29 which would be welded or fastened to a leg 22 may be used. The leg 22 could be made of wire, sheet metal or plastic.

As illustrated in FIG. 1, the second pet cage 10′ may be stacked on the pet cage 10 by use of the stacking spacers 40. The spacers 40 create space between the cages 10 and 10′ for ventilation, light and viewing while also keeping the pet cage 10′ positioned directly above the pet cage 10 and resistant to being dislodged from it. This latter accomplishment was made possible by use of bi-directional horizontal engagement with both the base of the second pet cage 10′ and the vertical walls 12 and or the roof 13 of the lower pet cage 10, as oriented in FIG. 1. The stacking spacers 40 and the base 18′ of the second pet cage 10′ may also be latched as was previously explained. The latching may stabilize the multiple stacking spacers 40 to prevent movement of one or more of the spacers 40 while the upper pet cage 10′ is being lowered in place.

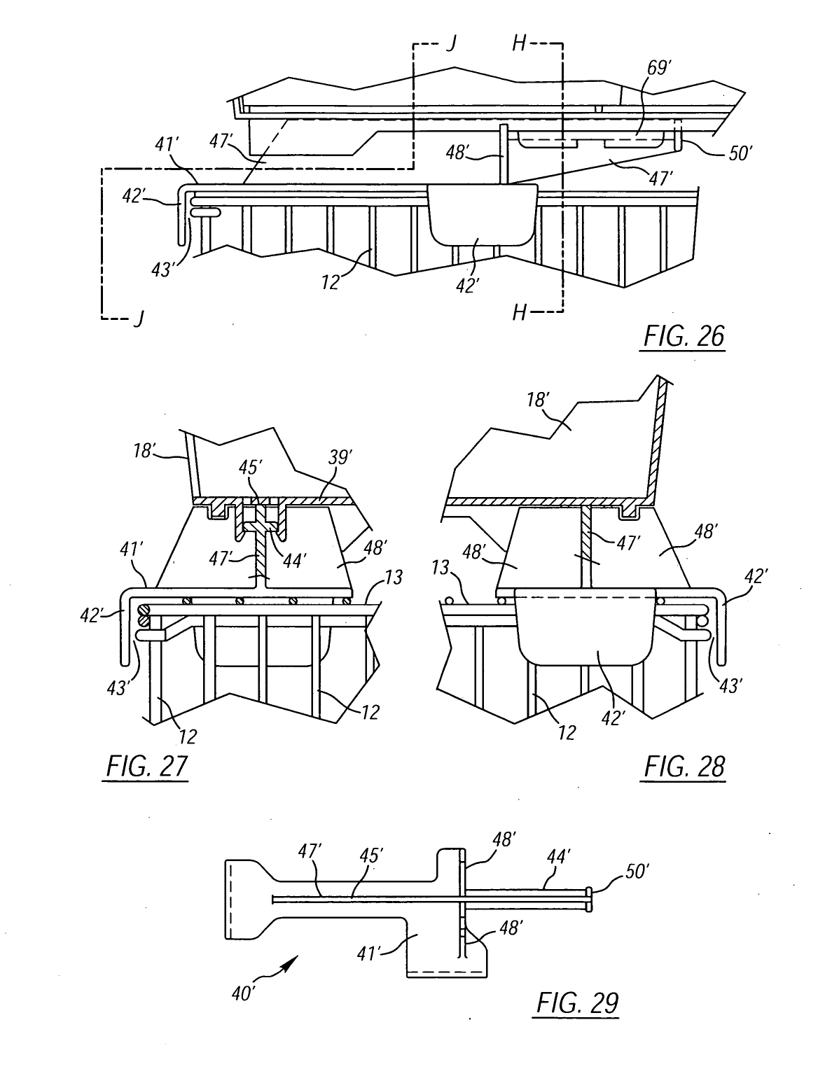

FIGS. 26 through 29 illustrate a first alternative stacking spacer 40′. The first alternative stacking spacer 40′ demonstrates an equivalency created by having a main member 41′ and a vertical web 47′ such that dual, downwardly extending flanges 42′ can be employed to engage two adjacent vertical walls 12 of the lower pet cage 10 while maintaining a similar clearance 43′ to them. As such, only four stacking spacers 40′ would be needed. The upper surface 45′ of the cross-member 44′ may extend for the entire length of the vertical web 47′. The stacking spacer 40′ may have only one cross-member 44′ and, if so configured, only four pairs of gripping fingers 69′ would be required descending from the bottom 39′ of the base 18′ of the second pet cage 10′. The cross-member 44′, as shown, is one of many shapes that may be employed to engage the gripping fingers 69′. Gussets 48′ may function similarly to those of the stacking spacer 40. An end cleat 50′, may restrict axial movement, and is displaced a distance from the gussets 48′, and more specifically, is displaced a slightly greater distance than the length of the pairs of gripping fingers 69′.

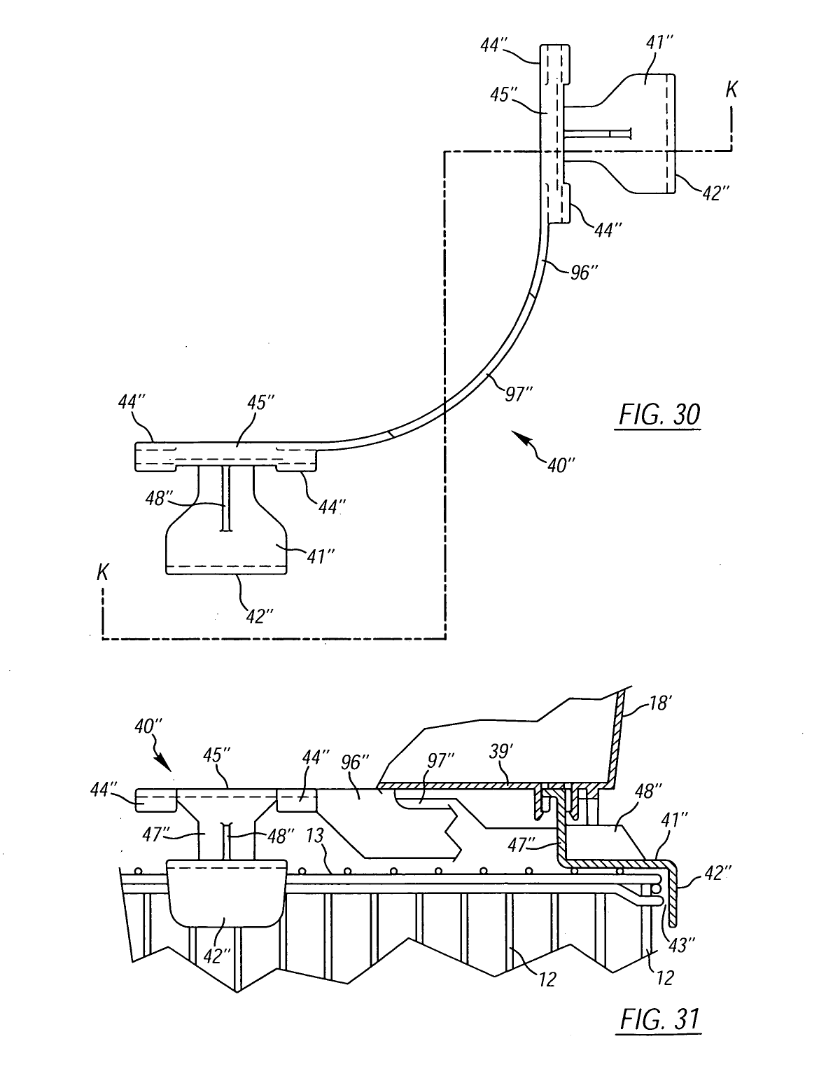

FIGS. 30 and 31 illustrate a second alternative stacking spacer 40″. The second stacking spacer 40″ is essentially a pair of the stacking spacers 40 with abbreviated main members 41″, vertical webs 47″ (FIG. 31) and gussets 48″. The inner most cross-member 44″ at one end is connected to the inner most cross-member 44″ at its other end by a connecting web 96″. An upper surface 45″ of the connecting web 96″ is contiguous with the upper surface 45″ of the cross-member 44″ and similarly serves to support the bottom 39′ of the base 18′ of the second pet cage 10′. The upper surface 45″ may be broken near a central portion by clearance notch 97″ which functions to avoid interference with the feed runners 76′ on the underside of the bottom 39′ of the base 18′. For purposes of clarity, the feed runners 76′ were not illustrated in FIG. 31. The connecting web 96″ functions as the means to restrict the axial movement of the cross-member 44″ within their respective pairs of gripping fingers 69′ by making the cross-member 44″ at one end serve to restrict the axial motion of the cross-member 44″ at the other end. Obviously, only four of the stacking spacer 40″ would be required, but eight pairs of gripping fingers 69′ would be needed.

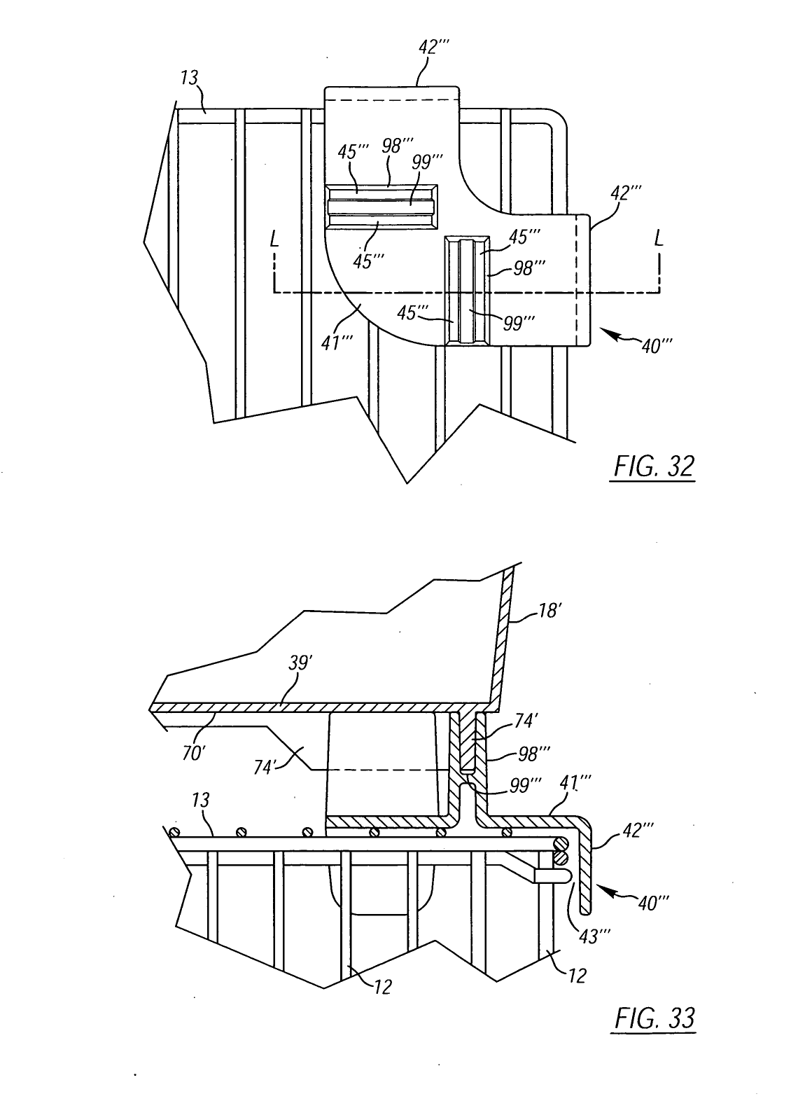

FIGS. 32 and 33 illustrate a third alternative stacking spacer 40′″. The third alternative stacking spacer 40′″ may function with the base 18′ of a second pet cage 10′ that was or was not equipped with pairs of gripping fingers 69′. The stacking member 40′″ has a main member 41′″ which rests upon the roof 13 of the pet cage 10 near corners of the pet cage 10 so that two downward extending flanges 42′″ overhang two adjacent vertical walls 12 with a clearance 43′″. The stacking spacers 40′″ may attach to the base 18′ of the second pet cage 10′ by frictionally gripping sides of both reaches of short legs 74′ that are located at the corners of the base 18′ of the second pet cage 10′. This is accomplished by two upward extending channels 98′″ whose gap 99′″ has approximately the same draft and width but a greater depth than that of the short legs 74′ of the second pet cage 10′. The upper surfaces 45′″ of the upward extending channels 98′″ function to support the lower surface 70′ of the bottom 39′ of the second pet cage 10′. Alternatively, two upward extending channels 98′″ may be separated, as illustrated in FIGS. 32 and 33, or connected with their contour accommodating that of the short legs 74′ of the second pet cage 10′. There may be four of the stacking spacers 40′″ required to support and grip a rectangular base 18′ of a second pet cage 10′. By frictionally gripping surfaces of short legs 74′ that are at right angles to each other, axial movement relative to the short legs 74′ is prevented.

The preferred and/or alternative embodiments of the pet cage 10, the base 18, the waste drawer 30, the stacking spacer 40 or the stand 20, may include circular, triangular, pentagonal, hexagonal or octagonal configurations without departing from the spirit of the invention.

The foregoing description is given for clearness of understanding only, and no unnecessary limitations should be understood therefrom, as modifications within the scope of the invention may be apparent to those having ordinary skill in the art.

What is claimed is:

1. A pet cage assembly comprising:
pet cage having a perimeter wall and a molded plastic base having a latch to engage the perimeter wall, the base having an apron surrounding the perimeter wall and extending outwardly and upwardly relative thereto; and
a grill and a waste drawer disposed within the base, the waste drawer being disposed below the grill, the waste drawer being adapted to collect waste and debris.

2. The pet cage of claim 1, wherein the waste drawer includes an upstanding wall that seals against at least a portion of the base to inhibit waste and debris from passing between where the upstanding wall of the waste drawer seals against the base to prevent waste and debris from collecting beneath the drawer.

3. The pet cage of claim 1, wherein the molded plastic base includes a bottom, a front wall, a rear wall, and a pair of side walls, the front wall having an opening formed therein, the grill and the waste drawer being slidably disposed within the base through the opening in the front wall thereof.

4. The pet cage of claim 3, wherein the apron extends outwardly and upwardly from the front wall, the rear wall, and the pair of side walls, the apron being curved such that an angle of the apron from a horizontal plane increases as the apron extends outwardly.

5. The pet cage of claim 1, wherein the apron is continuous so as to completely surround the perimeter wall of the pet cage and includes at least one integrally molded gusset to provide the base with support sufficient for a user to grip the apron alone when it is desired to move the cage.

6. The pet cage of claim 1, wherein the waste drawer further comprises a front wall that includes a pull handle, and an underside having ribs for supporting the waste drawer so it can slide and rest upon the bottom of the base.

7. A pet cage assembly comprising:
a pet cage having a perimeter wall that engages and latches to a molded plastic base having an upwardly and outwardly extending apron, the apron completely surrounding the base, the apron including at least one gusset to provide the base with support sufficient for a user to grip the apron alone when lifting and moving the cage; and
a grill and a waste drawer disposed within an opening in the base;
the waste drawer being disposed within the opening in the base below the grill for collecting waste and debris therein, the opening in the base permitting separate and independent lateral insertion and removal of the grill and waste drawer.

8. The pet cage of claim 7, wherein the apron of the base further includes at least two laterally extending hooks, the hooks serving to guide the grill during lateral insertion and removal.

9. The pet cage of claim 7, wherein the apron further comprises at least one stiffening flange to provide further support.

10. The pet cage of claim 7, wherein the apron further comprises at least one support rib extending upwardly from the apron, and at least one latch associated with the support rib for latching the perimeter wall of the pet cage to the base.

11. A stand assembly for a pet cage having a base, the stand assembly comprising:
at least three legs wherein each of the legs has an upper end and a lower end;
a horizontal member disposed between the legs generally in proximity to the lower ends thereof;
a clip associated with each of the legs for engaging the horizontal member, the horizontal member thereby stabilizing the lower ends of the legs; and
wherein at least one pair of grippers disposed on an underside of the base can grip the upper ends of the legs to maintain them in a desired geometrical relationship.

12. The stand assembly of claim 11, further comprising one or more tubular sleeves for engaging the upper ends of two adjacent legs, wherein the tubular sleeves are gripped by the grippers disposed on the underside of the base.

13. The stand assembly of claim 11, wherein each of the lower ends of the legs terminates in a bent foot that rests upon the floor.

14. The stand assembly of claim 11, further comprising a cross tie for stiffening and stabilizing each of the upper ends of the legs.

15. A base of a pet cage comprising:
a bottom, a front wall, a rear wall, and a pair of side walls, wherein the front wall has an opening to independently, slidably receive a grill and a waste drawer and the bottom has an underside with at least one pair of grippers for engaging at least one leg of a stand assembly.

16. The base of claim 15, wherein the pair of grippers engages an upper end portion of the leg of the stand assembly.

17. The base of claim 15, wherein the pair of grippers engages a tubular sleeve on the leg of the stand assembly.

18. The base of claim 15, wherein each of the pair of grippers includes a hook and a taper that ends at a narrow tip.

19. The base of claim 15, further comprising at least one pair of apertures disposed between the pair of grippers.

20. The base of claim 15, wherein the grippers are positioned generally at an equal distance from corners of the base.

21. The base of claim 15, further comprising integral legs disposed in the corners of the base, wherein the height of the legs is greater than the height of the grippers.

22. A molded plastic base of a pet cage assembly comprising:
an outwardly extending flange having at least one support rib extending upwardly therefrom; and
at least one latch associated with the support rib for engaging, positioning and retaining a wall of a pet cage to the base.

23. The base of claim 22, further comprising multiple latches for engaging and retaining a wall of a pet cage to the base, each of the latches being centered between a corresponding pair of support ribs disposed on the flange.

24. The base of claim 23, further comprising a web spaced from and located outside of each of the latches and extending between and connecting the corresponding pair of support ribs, thereby limiting outward deflection of the latches.

25. The base of claim 23, further comprising a laterally extending hook associated with each latch and rising above a surface of the flange so as to retain and guide a pet cage for engagement of the latch with the wall.

26. The pet cage assembly of claim 23, wherein the support ribs support and position a bottom wire of the wall above the surface of the flange so that debris slides under the bottom wire and into a waste drawer and the wire is kept in engagement with the latch.

27. The pet cage assembly of claim 26, wherein each of the latches deflects outwardly when the bottom wire of the wall of a pet cage is placed into the corresponding pair of support ribs disposed on the flange.

28. The pet cage assembly of claim 27, wherein the each of the latches has a tapered barb and springs back so that the tapered barb is above the bottom wire to thereby automatically lock the wall of a pet cage to the base.

29. The pet cage assembly of claim 28, wherein each of the latches is unlocked when the tapered barb is deflected outwardly to thereby allow a slight lift to the wall of a pet cage to a point above its latched location.

30. The pet cage assembly of claim 29, further comprising a web placed outside of the tapered barb to thereby permit the barb to deflect far enough to clear the bottom wire and release the wall of a pet cage without exceeding an elastic limit of the latch.

31. A set of spacers for stacking pet cages, each spacer comprising:
a first member for resting upon a top portion of a first pet cage; and
at least one downward extending flange for engaging the first pet cage;
wherein each spacer locates, engages, and spaces the underside of a second cage base relative to a top of the first pet cage.

32. The set of spacers of claim 31, the spacer further comprising one or more cross-members located at a top area of the spacer having an upper surface that is generally flat for supporting an underside of a second cage base.

33. The set of spacers of claim 32, wherein the cross-member includes a lower portion shaped to engage with and be removably restrained by grippers of the second pet cage.

34. The set of spacers of claim 32, wherein the cross-member is supported by a vertical web that rises from the first member and is braced by one or more gussets having an upper flat surface.

35. The set of spacers of claim 31, wherein each spacer is made of a clear material to avoid impeding light or a view of a pet in the cage.

36. The set of spacers of claim 31, further comprising at least one upward extending channel for supporting and engaging an underside of the second pet cage.

37. A pet cage assembly comprising:
a pet cage having a perimeter wall and a molded plastic base; and
a grill and a waste drawer slidably disposed within the base, the waste drawer disposed below the grill, the waste drawer being adapted to collect waste and debris;
the waste drawer having a wall at least a portion of which sealingly engages at least a portion of the base to prevent waste and debris from passing therebetween.

38. The pet cage of claim 37, wherein the wall of the waste drawer comprises two side walls and a rear wall each having an upwardly and outwardly angled upper portion that tapers to a thin edge, the angled upper portions of the rear and side walls of the drawer being adapted to flex so as to conform to the surface of corresponding rear and side walls of the base to provide a seal therebetween.

39. The pet cage of claim 38, wherein the base includes a releasable latch for engaging the perimeter wall of the pet cage.

40. The pet cage of claim 38, wherein the waste drawer further includes a front wall disposed outside an inner surface of a front wall of the base and a handle for withdrawal.

41. The pet cage of claim 37, wherein the grill rests upon a pair of surfaces of the base located above the waste drawer.

42. The pet cage of claim 41, wherein the grill is constrained to the pair of surfaces by two or more hooks disposed on the base above the grill.

43. A method of making a molded pet cage base, the method comprising the steps of:
injecting molding resin into a distribution ring disposed on an underside of the base;
distributing the resin to a perimeter wall of the base and through an apron surrounding the perimeter wall; and
distributing the resin to at least one gusset integral with the apron, such that the perimeter wall has a thickness that is less than 0.100 inches.

44. The method of claim 43, wherein the perimeter wall is 0.080 inches thick.

45. The method of claim 43, wherein the distribution ring has a substantially larger thickness than the perimeter wall.

46. The method of claim 43, wherein a plurality of feed runners radiate from the distribution ring and are oriented towards each corner of the base to promote a lateral flow of resin into the perimeter wall and apron.

47. The method of claim 46, wherein the feed runners have a substantially larger thickness than the perimeter wall.
